(19) United States
(12) Patent Application Publication
(10) Pub. No.: US 2017/0001893 A1
(43) Pub. Date: Jan. 5, 2017

(54) PROCESS AND APPARATUS FOR TREATING SPENT CAUSTIC SOLUTION

(71) Applicant: Linde Aktiengesellschaft, Munich (DE)

(72) Inventors: Darren GURNEY, London (GB); Gusberti AMBROGIO, München (DE)

(21) Appl. No.: 15/113,447

(22) PCT Filed: Jan. 28, 2015
(86) PCT No.: PCT/GB2015/000031

§ 371 Date: Jul. 22, 2016

(30) Foreign Application Priority Data
Jan. 28, 2014 (GB) 1401430.2

(51) Int. Cl. C02F 1/78; C02F 1/52; C02F 1/38; C02F 1/04; C02F 1/44; C02F 1/66

(52) U.S. Cl. CPC C02F 1/78; C02F 1/442; C02F 1/444; C02F 1/66; C02F 1/385; C02F 1/048; C02F 1/52; C02F 2101/101

(57) ABSTRACT

A process for treating a spent caustic solution and an apparatus for treating a spent caustic solution. The treatment provides an environmentally acceptable solution for discharge into a conventional wastewater treatment plant or for further processing. A spent caustic solution enters a reactor and is cycled through the reactor and into a process liquid line where it is contacted with ozone and with carbon dioxide to form a treated solution of pH 7.0 to 11.0.

The present invention relates to a process for treating a spent caustic solution and to an apparatus for treating a spent caustic solution. In particular, the invention relates to the treatment of a spent caustic solution which provides an environmentally acceptable solution for discharge into a conventional wastewater treatment plant or for further processing.

Caustic solutions are used to treat hydrocarbon streams produced in various hydrocarbon cracking processes (for example, steam cracking, fluid catalytic cracking (FCC) and thermal cracking) in oil refineries, petrochemical complexes and natural gas production plants. The sodium hydroxide solution is typically used to remove hydrogen sulphide, organic-sulphur contaminants and other acidic gases in the so called sweetening processes. For example, streams like ethylene, LPG (liquefied petroleum gas), light and heavy naphtha or kerosene, are washed in a liquid-liquid contactor with an aqueous sodium hydroxide solution and often combined with a suitable catalyst to remove impurities like hydrogen sulphide and mercaptans, typically by converting them either into sodium salts (e.g. NaHS, CH₃SNa), disulphides (CH₃SSCH₃) or napthenic salts. A portion of the caustic solution becomes spent and is removed from the process being replaced with fresh caustic solution. The spent aqueous caustic which results from such processes must be treated to remove the sulphide and organic compounds therein and to reduce the pH thereof in order to provide an acceptable effluent for discharge into a conventional wastewater treatment plant or wider environment, under certain operational licence consent limits.

One method of treating spent caustic solution is by a general group of technologies often referred to as wet air oxidation (WAO) processes. In this process spent caustic solution is introduced into a vessel where it is treated with high pressure air (typically around 8.0 to 210 barg) and elevated temperature (typically around 200 to >300° C.). Sulphides and other inorganic sulphur acid salts and mercaptans are oxidised to thiosulphate and sulphate ions and other oxidation products. An alternative to WAO is to burn the spent caustic solution in an incinerator (special waste incineration processes) but these incineration processes require the use of sophisticated air abatement technology and other complex operational equipment and an authorised operational licence for special waste disposal. Typically, therefore, wet air oxidation and special waste incineration processes are operated by third party companies in the waste treatment sector. Such WAO processes are capital intensive, have a high energy input to maintain the pressure (typically from 25 to 35 barg in medium WAO processes e.g. 30 barg) and the high temperatures required and the special incineration processes have the additional requirement of flue gas abatement, monitoring equipment and the disposal of solid waste.

It is one object of the present invention to overcome or address the problems of prior art processes/apparatus for treating spent caustic solution or to at least provide a commercially useful alternative thereto. It is an alternative and/or additional object to provide a process/apparatus for treating spent caustic solution which is more cost effective and/or more effective and/or more energy efficient than known processes.

In the first aspect of the present invention there is provided a process for treating spent caustic solution, the process comprising:
contacting a spent caustic solution with
   (i) a gas comprising ozone; and
   (ii) carbon dioxide;
to form a treated solution having a pH in the range of from 7.0 to 11.0; and discharging at least a portion of the treated solution.

In a further aspect of the present invention there is provided an apparatus for treating a spent caustic solution, the apparatus comprising:

a first reactor,

wherein the first reactor has an inlet for introducing a solution and an outlet for removing solution; and

the first reactor comprises a means for introducing a gas comprising ozone into the reactor and a means for introducing carbon dioxide into the reactor.

In a further aspect of the present invention there is provided an apparatus for treating a spent caustic solution, the apparatus comprising:

a first reactor, and

a second reactor;

wherein each of the first reactor and the second reactor has an inlet for introducing solution and an outlet for removing solution; and

wherein the first reactor and the second reactor are in fluid communication with one another, such that, in use, solution can be transferred from the first reactor to the second reactor,

the first reactor comprising a means for introducing a gas comprising ozone into the reactor; and

the second reactor comprising a means for introducing carbon dioxide into the reactor.

The present invention will now be further described. In the following passages different aspects of the invention are defined in more detail. Each aspect so defined may be combined with any other aspect or aspects unless clearly indicated to the contrary. In particular any feature indicated as being preferred or advantageous may be combined with any other feature or features indicated as being preferred or advantageous.

As used herein the term “spent caustic solution” includes an aqueous alkali metal hydroxide solution comprising sulphur derived compounds and/or amines and/or heavy metals and salts and mixtures thereof. The sulphur derived compounds include sulphides, disulphides, mercaptans and/or phenols.

Typically the sulphides, disulphides, mercaptans, phenols and/or amine compounds have been obtained from the treatment of hydrocarbon fluids with the aqueous alkali metal hydroxide solution and typically these compounds will be in the form of alkali metal salts. Typically the heavy metals are derived from the catalyst that can be added to the aqueous alkali metal hydroxide solution. Typically, the heavy metals are cobalt and/or molybdenum. Alternatively, or additionally, the heavy metals have been obtained from the treatment of hydrocarbon fluids with the aqueous alkali metal hydroxide solution.

Typically the spent caustic solution will be treated using the described process when it cannot absorb/react with any more organic/inorganic sulphur compounds. However, the process may also be used for treating a caustic solution which has a reduced or depleted ability to absorb/react with any more organic/inorganic sulphur compounds.

The spent caustic solution may include, for example, spent aqueous potassium hydroxide solutions and/or spent aqueous sodium hydroxide solutions. Such aqueous alkali metal hydroxide solutions are widely used for treatment of a variety of mercaptan containing hydrocarbon streams, including liquid petroleum gas (LPG), butanes, butenes, gasoline streams and naphthas and the like. These spent aqueous alkali metal hydroxide solutions resulting from the treatment of the aforementioned hydrocarbon streams can typically contain a number of different mercaptan sulphur compounds, including, for example, such mercaptans as methyl mercaptan, ethyl mercaptan, n-propyl mercaptan, iso-propyl mercaptan, n-butyl mercaptan, and thiophenol. Alkali metal sulphides can also be present in such spent aqueous alkali metal hydroxide solutions due to the presence of hydrogen sulphide in the hydrocarbon streams which were previously treated with the aqueous alkali metal hydroxide solution.

The spent caustic solution may include, for example trace amounts of or greater, volatile organic compounds (VOCs), absorbed therein during treatment of hydrocarbon streams.

Preferred aqueous alkali metal hydroxide solutions used in the hydrocarbon sweetening process are solutions of sodium hydroxide and/or of potassium hydroxide. Preferably the aqueous alkali metal hydroxide solution is a caustic solution comprising sodium hydroxide.

Typically the caustic solution used in the hydrocarbon sweetening process comprises from 4 to 15% w/v sodium hydroxide solution. Alternatively, the caustic solution used in the hydrocarbon sweetening process comprises from 4 to 10% w/v sodium hydroxide solution, more preferably from 4 to 8% w/v, or from 7 to 15% w/v, or from 10 to 15% w/v sodium hydroxide solution.

Preferably, the caustic solution used in the hydrocarbon sweetening process comprises from 4 to 15% w/w sodium hydroxide solution. More preferably, the caustic solution used in the hydrocarbon sweetening process comprises from 4 to 10% w/w sodium hydroxide solution, more preferably from 4 to 8% w/w, or from 7 to 15% w/w, or from 10 to 15% w/w sodium hydroxide solution.

Once these caustic solutions have been used for scrubbing/cleaning sour gases and/or compounds from fuel gases such as, kerosene, LPG and other fuels, a portion of the solution eventually becomes spent. The spent solution may not be able to absorb/react with, or to effectively and/or efficiently absorb/react with, more organic/inorganic sulphide compounds. Thus, it is necessary to treat the spent aqueous caustic solution.

Preferably, the spent caustic solution comprises sodium hydroxide.

Preferably, in a multi-reactor embodiment, the spent caustic solution is contacted with a gas comprising ozone in a first reactor to form a partially treated solution and the partially treated solution is contacted with carbon dioxide in a second reactor to form the treated solution.

The term ‘partially treated solution’ is understood to refer to the spent caustic solution, or portion thereof, that, within one particular cycle, has been contacted with a gas comprising ozone but has not yet been contacted with carbon dioxide. For example, the partially treated solution includes spent caustic solution that has been contacted/treated with a gas comprising ozone in the first reactor but has not yet been contacted/treated with carbon dioxide in the second reactor in order to form the treated solution.

The spent caustic solution is treated by contacting it with a gas comprising ozone. Preferably, the gas comprising ozone is bubbled through the spent caustic solution in the first reactor to form the partially treated solution.

Preferably, contacting the partially treated solution with carbon dioxide to form the treated solution is carried out after the spent caustic solution has been contacted with a gas comprising ozone to form said partially treated solution.

Preferably the carbon dioxide is in the form of a gas. Preferably, the carbon dioxide is bubbled through the partially treated solution to form the treated solution having a pH in the range of from 7.0 to 11.0. In one preferable embodiment, the carbon dioxide is bubbled through the partially treated solution to form the treated solution having a pH in the range of from 7.0 to 9.0. At least a portion of the treated solution having a pH in the range of from 7.0 to 9.0 may then be discharged as a discharge solution having a pH in the range of from 7.0 to 9.0. In an alternative preferable embodiment, the carbon dioxide is bubbled through the partially treated solution to form the treated solution having a pH in the range of from 10.0 to 11.0. The treated solution having a pH in the range of from 10.0 to 11.0 may then be subjected to one or more further steps, for example, the addition of further carbon dioxide to reduce the pH of the solution to 7.0 to 9.0, or the removal of heavy metal carbonates and/or heavy metal oxides as precipitate from the treated solution, prior to discharging at least a portion of said treated solution.

The carbon dioxide as described herein may be provided by a carbon dioxide source, for example, from a tank or canister. In a preferred embodiment, at least a portion of the carbon dioxide contacted with the spent caustic solution is derived from the combustion of off-gas in the presence of hydrogen, the off-gas comprising volatile organic compounds and optionally ozone and/or oxygen and/or acid gases that were absorbed by the spent caustic solution during treatment of hydrocarbon streams.

Preferably therefore, the spent caustic solution comprises volatile organic components and the process thereby produces an off-gas comprising at least a portion of said volatile organic components. Preferably at least a portion of the off-gas is combusted in the presence of hydrogen to produce a recycle stream comprising carbon dioxide and optionally other combustion products; and the spent caustic solution is contacted with at least a portion of the recycle stream.

The off-gas is typically released at a gas/liquid interface. The off-gas preferably comprises at least a portion of any volatile organic compounds (VOCs) such as aldehydes and/or ketones and/or alcohols present in the spent caustic solution. Preferably, the off-gas also comprises oxygen and/or ozone and/or H₂S and/or carbon dioxide. Preferably the off-gas is combusted with hydrogen to produce a recycle stream comprising carbon dioxide and/or SOₓ species (e.g. H₂SO₄, H₂SO₃, S₂O₃, and SO₃) and/or NOₓ species and/or other oxidation products. More preferably, the recycle stream further comprises one or more of H₂SO₄, H₂SO₃, S₂O₃, SO₃, N₂O₅, NH₄NO₃ and NO₂. As oxygen is preferably in excess, each of the oxidation products is preferably in its oxidised form.

Preferably the process further comprises mixing at least a portion of the recycle stream with the gas comprising ozone and/or the carbon dioxide before contacting the spent caustic solution. In particular, preferably, at least a portion of the recycle stream comprising carbon dioxide and/or SOₓ species (e.g. H₂SO₄) and/or NOₓ species and/or other oxidation products is then recycled and contacted with the spent and/or partially spent caustic solution to reduce the pH thereof.

Preferably, the first and the second reactors are in fluid communication with one another. The first and second reactors may be two separate, distinct reactors. Alternatively, or additionally, the first and second reactors may be sections of one reactor i.e. both first and second reactors may be contained within one vessel.

Contacting the spent caustic solution with a gas comprising ozone may be carried out in more than one first reactor and/or contacting the partially treated solution with carbon dioxide may be carried out in more than one second reactor.

Preferably, at least a portion of the treated solution is recycled from the second reactor to the first reactor. The recycled solution will then be further treated with ozone and carbon dioxide before being discharged.

Alternatively, in a single-reactor embodiment, preferably the spent caustic solution is contacted with a gas comprising ozone and carbon dioxide in a first reactor to form the treated solution.

Preferably, (i) the gas comprising ozone and (ii) carbon dioxide are introduced into the first reactor through a first inlet (i.e. both (i) the gas comprising ozone and (ii) carbon dioxide enter the first reactor through the same inlet). Preferably, the carbon dioxide is gaseous. Preferably, (i) the gas comprising ozone and (ii) carbon dioxide are mixed before entering the first reactor and contacting the spent caustic solution. For example, (i) the gas comprising ozone and (ii) carbon dioxide preferably enter the first reactor through the same inlet after being mixed in a means for mixing a gas comprising ozone and carbon dioxide. The means for mixing may include a venturi gas/liquid contactor (optionally located in a pumped recycle sidestream), one or more diffusers (located, for example, in the first reactor for directly dissolving the gas(es) into the spent caustic solution), a jet mixer, an impellor mixer and diffuser combination or a contact column comprising perforated plates and/or baffles.

Preferably, at least a portion of (i) the gas comprising ozone and (ii) carbon dioxide are mixed to provide a gas mixture comprising ozone and carbon dioxide before contacting the spent caustic solution and/or the partially treated solution.

Preferably, this gas mixture also comprises oxygen (O₂) and/or nitrogen (N₂). Preferably, the gas mixture comprises carbon dioxide, ozone, oxygen and/or nitrogen, the gas comprising from 5% to 20% by volume of ozone based on the total volume of the gas. Preferably, when the gas mixture also comprises oxygen, the gas mixture comprises 10% to 12% by volume of ozone based on the total volume of the gas.

Alternatively, preferably, the gas mixture comprises carbon dioxide, ozone, nitrogen and/or air, and the gas comprises from 10% to 20% by volume of ozone based on the total volume of the gas.

Alternatively, preferably, the gas mixture comprises carbon dioxide, ozone, and oxygen, and the gas comprises from 5% to 9% by volume of ozone, from 10% to 40% by volume of carbon dioxide and from 55% to 81% by volume of oxygen based on the total volume of the gas.

Preferably, the gas mixture is then contacted with the spent caustic solution and/or the partially treated solution.

Alternatively, (i) the gas comprising ozone and (ii) carbon dioxide are not mixed before entering the first reactor and are introduced separately into the first reactor through separate inlets before contacting the spent caustic solution in the reactor. It is understood that (i) the gas comprising ozone and (ii) carbon dioxide may be contacted with the spent caustic solution in any order. For example, preferably, the spent caustic solution is contacted with carbon dioxide after being contacted with the gas comprising ozone. Alternatively, preferably, the spent caustic solution is contacted with the gas comprising ozone at the same time as being contacted with carbon dioxide, i.e. (i) the gas comprising ozone and (ii) carbon dioxide are entered at the same time into the reactor via separate inlets to contact the spent caustic solution.

Preferably, (i) the gas comprising ozone and (ii) carbon dioxide, as a gaseous mixture or separately, are bubbled through the spent caustic solution in the first reactor to form the treated solution having a pH in the range of from 7.0 to 11.0.

Optionally, preferably, at least a portion of the spent caustic solution is contacted with the gas comprising ozone and/or the carbon dioxide prior to introducing the portion of the spent caustic solution and the gas comprising ozone and/or the carbon dioxide into the first reactor. For example, at least a portion of the spent caustic solution may be contacted or mixed with a gas comprising ozone and/or carbon dioxide in a venturi type mixer. Alternatively, the at least a portion of the spent caustic solution may be contacted or mixed with a gas comprising ozone and/or carbon dioxide in a jet mixer, an in-line static mixer, a diffuser (which may be located in the base of the reactor) or in a pumped recycle sidestream with a gas/liquid contacting device. The resulting liquid/gas mixture (i.e. at least a portion of the spent caustic solution and a gas comprising ozone and/or carbon dioxide) may be introduced together, as a mixture, into the first reactor via one or more inlets in the first reactor, for example through a distributor or nozzle array.

The first reactor is preferably one separate, distinct reactor having one or more sections. Contacting the spent caustic solution with a gas comprising ozone and carbon dioxide may be carried out in more than one first reactor.

Preferably, the gas comprising ozone comprises from 10% to 15% ozone, or from 10 to 12%, or from 12 to 15% by volume of ozone based on the total volume of the gas. Alternatively, preferably, the gas comprising ozone comprises from 5% to 20% by volume of ozone, or from 10% to 20% by volume of ozone, or from 11% to 19%, or from 12% to 18% by volume of ozone based on the total volume of the gas.

Preferably, the gas comprising ozone also comprises oxygen (O₂). Preferably, the gas comprising ozone comprises at least 80% by volume of oxygen, or at least 82% or at least 85% by volume of oxygen, or at least 88% or at least 90% by volume oxygen based on the total volume of the gas.

Alternatively, preferably, the gas comprising ozone also comprises nitrogen (N₂). Preferably, the gas comprising ozone comprises at least 80% by volume of nitrogen, or at least 82% or at least 85% by volume of nitrogen, or at least 88% or at least 90% by volume nitrogen based on the total volume of the gas.

Alternatively, preferably, the gas comprising ozone also comprises oxygen (O₂) and nitrogen (N₂). Preferably, the oxygen and nitrogen may be provided in the form of air. Preferably, the gas comprising ozone also comprises oxygen and nitrogen in the form of air and comprises from 5% to 20% by volume of ozone, or from 10% to 20% by volume of ozone, or from 11% to 19% or from 12% to 18% by volume of ozone based on the total volume of the gas.

Preferably, the gas comprising ozone consists, or consists essentially, of oxygen and ozone. If the gas comprising ozone consists, or consists essentially, of oxygen and ozone, preferably it consists of at least 10%, or at least 15% by volume of ozone based on the total volume of the gas.

Preferably, the gas comprising ozone consists, or consists essentially, of nitrogen and ozone. If the gas comprising ozone consists, or consists essentially, of nitrogen and ozone, preferably it consists of at least 10%, or at least 15% by volume of ozone based on the total volume of the gas.

Preferably, the gas comprising ozone consists, or consists essentially, of oxygen, nitrogen and ozone. If the gas comprising ozone consists, or consists essentially, of oxygen, nitrogen and ozone, preferably it consists of at least 10%, or at least 15% by volume of ozone based on the total volume of the gas.

Preferably, the gas comprising ozone comprises a percentage volume ratio of ozone to oxygen of about 10% to about 15%. More preferably, the gas comprising ozone comprises a percentage volume ratio of ozone to oxygen of about 1:9. The ratio is measured by volume.

Preferably, the partially treated solution/the spent caustic solution is contacted with carbon dioxide (preferably gaseous) to form the treated solution having a pH in the range of from 7.0 to 11.0. It is understood that the treated solution has a pH in the range of from 7.0 to 11.0 when it is formed and before said treated solution is subjected to any further processing steps. In one preferable embodiment, the partially treated solution/the spent caustic solution is contacted with carbon dioxide (preferably gaseous) to form the treated solution having a pH in the range of from 7.0 to 10.5, more preferably from pH 7.0 to 10.0, or pH 7.0 to 9.5, or pH 7.0 to 9.0, most preferably pH 7.0 to 8.5. In an alternative preferable embodiment, the partially treated solution/the spent caustic solution is contacted with carbon dioxide (preferably gaseous) to form the treated solution having a pH in the range of from 10.0 to 11.0, more preferably from pH 10.25 to 10.75.

The pH of the solution may be measured using a suitable pH electrode and reference electrode connected to an in-line pH meter in a sample loop. Suitable pH meters are available from manufacturers such as Endress & Hauser, Yokogawa, Emmerson Rosemount, LTI and ABB Kent.

It is understood that the partially treated solution/the spent caustic solution may be contacted with carbon dioxide (preferably gaseous) in one or two or three or more separate pulses, i.e. a set amount of carbon dioxide may be added to the partially treated solution/the spent caustic solution and then a second and/or third or more set amount of carbon dioxide may be added at a later point (e.g. after the solution reaches an appropriate temperature) to the partially treated solution/the spent caustic solution. Adding the carbon dioxide in one pulse may be advantageous as the desired pH may be reached more quickly. Alternatively, it may be advantageous to add the carbon dioxide in two or more pulses in order to keep the temperature of the process at the desired level. This is because the neutralisation reaction involving the carbon dioxide is exothermic and may therefore increase the temperature of the reactants.

Preferably, the carbon dioxide is in the form of a gas. Preferably, the partially treated solution/the spent caustic solution is treated with a gas comprising at least 40%, or at least 50%, or at least 60%, or at least 70%, or at least 80%, or at least 90%, or at least 100% by volume of carbon dioxide based on the total volume of gas introduced. Preferably, the carbon dioxide is bubbled through the partially treated solution/the spent caustic solution to form the treated solution.

Exposing the spent caustic solution to ozone oxidises a proportion of the organic and/or inorganic sulphur species present in the solution. Preferably, sufficient ozone is added such that substantially all the organic and/or inorganic sulphur species present in the spent caustic solution are oxidised by the ozone/oxygen to their highest oxidation state. Preferably the chemical oxygen demand (typically measured in mg O₂/litre) of the solution will be reduced by at least 10% and preferably at least 20% or 25% and typically by approximately 40%, oxygen demand. A standard method for measuring chemical oxygen demand may be found in Standard methods ISO 15705:2002 (Water quality—Determination of the chemical oxygen demand index (ST-COD)—Small-scale sealed-tube method) and ISO 6060:1989 (Water Quality—Determination of the chemical oxygen demand).

Without wishing to be bound by any particular theory, it is thought that sulphide is preferably oxidised into sulphate via sulphite by the following reactions:

S²⁻+3O₃→SO₃²⁻+3O²

SO₃²⁻+O₃→SO₄²⁻+O₂

giving an overall reaction of

S²⁻+4O₃→SO₄²⁻+4O₂

This reaction implies a consumption of 6 mg ozone/mg S²⁻.

Hydraulic residence time of the solution in the first reactor can be varied with the optimum period being determined by such factors as mercaptan level, ozone concentration, efficiency of mixing, temperature and other operating parameters. Residence times of from about 2 hours, or 6 hours, or 12 hours, to about 24 hours, or to about 48 hours, or to about 72 hours or longer will provide acceptably high levels of conversion of mercaptan to alkali metal sulphates and carbonates in most cases. The oxidation may be affected at ambient temperature (for example from about 20° C. to about 50° C., or from about 25° C. to about 50° C. or from about 20° C. to about 30° C., or from about 25° C. to about 30° C.) but can also be carried out at an elevated temperature of from about 50° C. to 140° C., or from about 60° C. to 130° C., or from 70° C. to 120° C.

As a result of treating the spent caustic solution with ozone/oxygen, the chemical oxygen demand is reduced prior to downstream wastewater treatment stages, further reducing the treatment demand in the wastewater treatment stage. The quantity of ozone and residence time of the spent caustic solution in the first reactor can be arranged to convert at least a substantial quantity of alkali metal disulphides of in the solution to sulphates and carbonates. Conversion levels in excess of about 50 weight percent (wt %), or 60 wt %, or 70 wt %, or 80 wt %, and preferably at least about 90 wt % of the total disulphides originally present in the solution are achievable.

The presence of organo/inorganic sulphide/sulphur containing compounds may be measured using GCMS (gas chromatography mass spectrometry), thin layer chromatography (TLC) or other known analytical techniques.

The amount of (preferably gaseous) carbon dioxide introduced into the system is typically controlled by pH measurement of the solution. The carbon dioxide introduced into the process is proportional to the rate of change in pH. The carbon dioxide injection is preferably ceased when the target pH of the solution is reached.

It is advantageous to use carbon dioxide in order to reduce the pH of the solution, rather than for example H₂SO₄ solution, because addition of further sulphur containing compounds increases the amount of sulphur in the process, which potentially has further negative environmental consequences. Moreover, the use of carbon dioxide as a pH change agent is preferred as it is self-buffering and it is much easier to control the final pH value to be the desired pH value. For example, the desired pH value may be around the typical range of pH 7.0 to 9.0, or from pH 7.0 to 8.5, normally acceptable for discharge into conventional biological wastewater treatment processes or to the wider environment. Alternatively, the desired pH value may be in the range of pH 10.0 to 11.0, or pH 10.25 to 10.75, or around pH 10.5, the typical pH values at which heavy metal carbonates/heavy metal oxides tend to precipitate out of the treated solution. Furthermore, carbon dioxide is not an aggressive/strong acid and the requirements for containment, safety showers, specialist materials and manual handling are not are not needed.

Preferably, contacting the spent caustic solution with (i) a gas comprising ozone and/or (ii) carbon dioxide is carried out at a temperature in the range of from about 20° C. to about 140° C., or from about 25° C. to about 140° C., or from about 25° C. to about 120° C., or from about 30° C. to about 130° C., more preferably from about 40° C. to about 130° C., or from about 50° C. to about 130° C., or from about 50° C. to about 120° C., or from about 60° C. to about 130° C., or from about 70° C. to about 130° C. More preferably still, contacting the spent caustic solution with (i) a gas comprising ozone and/or (ii) carbon dioxide is carried out at a temperature in the range of from about 80° C. to about 120° C.

Alternatively, preferably, contacting the spent caustic solution with (i) a gas comprising ozone and/or (ii) carbon dioxide is carried out at a temperature in the range of from about 20° C. to about 100° C., or from about 25° C. to about 80° C., or from about 25° C. to about 70° C., or from about 25° C. to about 60° C., or from about 25° C. to about 50° C.

Any suitable means may be used to measure the temperature, for example, temperature sensors, thermistors, probes etc. One advantage of the process described is that the spent caustic solution may successfully be treated at significantly lower temperatures, therefore reducing the energy requirements compared to other known methods

Maintaining or increasing the temperature during the ozonation and/or carbon dioxide pH control may be particularly important in batch reactions. This is because initially, the spent caustic solution may be below the activation energy required to promote the oxidation (ozonation) reaction. Both the oxidation reactions and the neutralisation/pH control may produce heat as they are considered to be exothermic. Therefore heating may be required only in the initial stages of a batch reaction or as incremental heating.

Preferably, the spent caustic solution is heated to a temperature of from about 20° C. to about 140° C., or from about 25° C. to about 140° C., or from about 40° C. to about 120° C., or from about 50° C. to about 100° C., more preferably from about 50° C. to about 90° C., or from about 60° C. to about 85° C., before being contacted with (i) a gas comprising ozone and (ii) carbon dioxide. More preferably still, the spent caustic solution is heated to a temperature in the range of from about 70° C. to about 85° C., or from about 75° C. to about 80° C. before being contacted with (i) a gas comprising ozone and (ii) carbon dioxide. Heating the spent caustic solution to such temperatures can be advantageous in locations where ambient temperatures can be low, for example 10° C. or 5° C. or lower. Heating the spent caustic solution (i.e. increasing its temperature) to such temperatures may advantageously accelerate the chemical reactions of the process. However, in some embodiments, a balance must be struck between the rate of reaction and other factors. For example, it is thought that heating the spent caustic solution to higher temperatures (e.g. higher than 140° C.) may be disadvantageous because components of the spent caustic solution may start to boil or become less predictable, potentially causing difficulty in effectively controlling the process, and also the higher the temperature of the spent caustic solution, the longer the apparatus/solution will take to cool to a temperature at which the solution can be discharged or subjected to other process steps and the apparatus can be re-used, cleaned, fixed etc.

In one embodiment, it may be advantageous if the spent caustic solution is not heated to a temperature higher than 85° C., or higher than 80° C. before being contacted with (i) a gas comprising ozone and (ii) carbon dioxide, because the oxidation and neutralisation reactions with ozone and carbon dioxide respectively are exothermic reactions and therefore these chemical reactions may further increase the temperature of the spent caustic solution to, for example, about 90° C. to about 140° C., or about 100° C. to about 140° C., or about 100° C. to about 130° C., thereby increasing the rate of reaction without causing the potential disadvantages described above associated with temperatures of more than, for example, 140° C.

Alternatively, for example in locations where ambient temperatures are higher, heating the spent caustic solution may be unnecessary because the spent caustic solution may be at temperatures of around 50° C. to 80° C. or higher before being introduced into the process described herein. As discussed above, such temperatures may provide a desirable reaction rate and the neutralisation and oxidation reactions may further increase the temperature/rate of reactions so it may be unnecessary to heat the spent caustic solution before is contacted with (i) a gas comprising ozone and (ii) carbon dioxide.

The discharging of at least a portion of the treated solution may be carried out at any suitable temperature. If the treated solution is to be discharged to an on-site biological treatment plant, it may be preferable for the temperature of the treated solution to be reduced to below about 35° C. before discharge. Normally this would not be problematic as the flow rate from the caustic treatment process would not be large compared to the daily flow being sent to the wastewater treatment plant.

Preferably, the process described herein is carried out at a pressure of less than about 5.0 barg, preferably at a pressure of less than about 3.0 barg, more preferably at a pressure of less than about 2.0 barg. Preferably, the process is carried out at a pressure in the range of from about 1.0 barg to about 5.0 barg, or from about 1.0 barg to about 3.0 barg, or from about 1.5 barg to about 3.0 barg. Most preferably, the process is carried out at a pressure in the range of from about 1.0 barg to about 2.5 barg. Any suitable means may be used to measure the pressure, for example, a pressure sensor, or a pressure gauge. One advantage of the process described is that the spent caustic solution may successfully be treated at significantly lower pressures compared to other known methods, e.g. WAO processes, therefore reducing the energy and special fabrication requirements compared to other known methods. Preferably, contacting the spent caustic solution with (i) a gas comprising ozone and/or (ii) carbon dioxide is carried out at the above pressures. Typically the discharge stage will be carried out at ambient pressure.

Alternatively, preferably, the gas comprising ozone and/or the carbon dioxide is provided to the first and/or second reactor at a pressure of about 0.5 to 1.0 barg above the operating pressure of the first and/or second reactors. Preferably, the gas comprising ozone and/or the carbon dioxide is provided to the first and/or second reactor at a pressure of about 1.5 to about 6.0 barg, or from about 1.5 to about 5.0 barg, or from about 1.5 to about 4.0 barg, or from about 1.5 to about 3.0 barg, with the proviso that the pressure of the gas comprising ozone and/or the carbon dioxide provided is at least about 0.5 barg higher than the pressure in the first and/or second reactor. This differential in pressure is advantageous as it may overcome the back pressure of the system and may allow for pressure losses incurred when the gas encounters a fitting and/or pipework.

Preferably, the process is carried out in a continuous process. Continuous processes may be advantageous as operating flexibility is increased (the run-time may be altered) and there is less or no ‘down-time’, thereby increasing the efficiency of the process.

Alternatively, preferably, the process is carried out in a batch process. Batch processes may be advantageous, allowing for additional hydraulic residence time in the reactor, as often the spent caustic solution is produced only once per week. This may be preferable for some refinery operations which are used to operating batch rather than continuous processes.

Preferably, the process (as a batch or continuous process) further comprises monitoring information such as:

(i) the pH of the solution;

(ii), the heat generated by the combustion of the off-gas with hydrogen;

(iii) the combustion products produced from the combustion of the off-gas with hydrogen;

(iv) the total organic carbon of the solution; and/or

(v) the chemical oxygen demand of the solution.

Preferably this information is communicated to a Programme Logic Controller (PLC) and the PLC adjusts the amount and/or make-up of the gas comprising ozone and/or carbon dioxide accordingly. For example, if the pH of the solution is high, the PLC may increase the amount of carbon dioxide being sent to contact the solution in order to reduce the pH thereof. Alternatively, if the heat generated by the combustion of off-gas with hydrogen is high, meaning more carbon dioxide is being produced in the combustion vessel and recycled to the reactor, the PLC will reduce the amount of carbon dioxide taken from other sources.

Moreover, the amount of oxidisable material (e.g. VOCs) present in the spent caustic solution may determine the amount of energy released as heat when any off-gas is combusted with hydrogen. This level of oxidisable material and/or the combustion heat generation can be measured and monitored by a PLC to control the amount of hydrogen added to the reaction as fuel and the amount of oxygen/ozone (oxidising agent) added to the spent caustic solution or added to the combustion reaction directly.

The PLC controls the introduction of particular gases to the process described herein by opening and closing valves or by operating mass flow controllers. Suitable PLCs, valves (e.g. actuated valves) and mass flow controllers are known in the art.

Combustion by-products can also be measured and used to determine when a reaction has reached completion or to make incremental or step changes to the proportions of gases. For example, if the amount of ozone measured is constant, it could be assumed that there is no reaction of ozone with the spent caustic solution and so the PLC may or reduce the amount of ozone provided to the solution, thereby improving the economics and efficiency of the process.

Mixtures of gases as described herein may be produced by a standard gas mixing skid and either injected into a common gas manifold where mixing may occur or premixed with a static in-line mixer or small mixing vessel and then introduced into the manifold before being provided to the spent caustic solution, e.g. in the first and/or second reactor.

Preferably, the spent caustic solution comprises heavy metals. Preferably, the heavy metals comprise cobalt and/or molybdenum. Preferably, the process further comprises removing heavy metal carbonates and/or heavy metal oxides as precipitate from the treated solution prior to discharging at least a portion of said treated solution, wherein the treated solution has a pH in the range of from 10.0 to 11.0 prior to removing the heavy metal carbonates and/or heavy metal oxides as precipitate. More preferably, the treated solution has a pH in the range of from 10.25 to 10.75, or a pH of around 10.5 prior to removing the heavy metal carbonates and/or heavy metal oxides as precipitate, which is the typical pH at which a heavy metal carbonate and/or a heavy metal oxide will precipitate from solution. It is understood that different heavy metal carbonates and/or different heavy metal oxides will precipitate out at slightly different pH values, depending on the properties of the specific heavy metal.

Preferably, heavy metal carbonates and/or heavy metal oxides are removed via coagulation, filtration, gravity settlement, one or more hydrocyclones, centrifugation and/or evaporation.

Preferably, when the heavy metal carbonates and/or heavy metal oxides are removed via filtration, the heavy metal carbonates and/or heavy metal oxides are removed via nano-filtration and/or ultra-filtration.

Preferably, the process further comprises heating the removed heavy metal carbonates to a temperature of from about 400° C. to about 800° C. to recover heavy metals and/or heavy metal oxides. More preferably, the removed heavy metal carbonates are heated to a temperature of from about 500° C. to about 700° C.

Preferably, the process further comprises reducing the pH of the treated solution after removing heavy metal carbonates and/or heavy metal oxides. For example, the pH may be reduced by the addition of carbon dioxide, an alternative acid, for example a mineral acid such as sulphur dioxide. Preferably, the process further comprises contacting the treated solution after removal of heavy metal carbonates and/or heavy metal oxides with carbon dioxide to form a treated solution having, for example, a pH in the range of from 7.0 to 9.0.

Preferably, the process involves discharging at least a portion of the treated solution having a pH in the range of from 7.0 to 11.0. Preferably, the portion of the treated solution discharged is discharged as a discharge solution having a pH in the range of from 7.0 to 10.0, or from 7.0 to 9.0. More preferably, the pH of the discharge solution is from pH 7.0 to 8.5, or from pH 7.0 to 8.0.

Preferably, the discharge solution is discharged to a wastewater plant or into the wider environment, e.g. a canal. Alternatively, and/or additionally, the discharge solution may be subjected to further treatment, for example, filtration, nanofiltration, biological treatment and other physio-chemical processes.

Advantageously, the described process may be carried out in a continuous process, a substantially continuous or a batch process.

The described process/apparatus also has the advantage that it can be carried out/used on-site (i.e. it can be carried out/used at the site where the spent caustic solution is produced). This is advantageous because complex, high-pressure-, high-temperature- and chemical resistant reactors are not required in order to carry out the described invention. A further advantage of the invention is that the oxidation process by ozone is carried out in the aqueous phase. Thus, air abatement technology is not required. This results in much lower day-to-day operating costs, initial investment capital and maintenance costs.

Unless specified otherwise, it is understood that all of the above preferable features apply equally to both the single-reactor process embodiment and the multi-reactor process embodiment.

In a single-reactor embodiment, the present invention provides an apparatus for treating a spent caustic solution, the apparatus comprising:

a first reactor,

wherein the first reactor has an inlet for introducing a solution and an outlet for removing solution; and

the first reactor comprises a means for introducing a gas comprising ozone into the reactor and a means for introducing carbon dioxide into the reactor.

It is understood that the means for introducing a gas comprising ozone into the reactor and the means for introducing carbon dioxide into the reactor may be the same means or separate/distinct means. For example, the gas comprising ozone and carbon dioxide may be introduced into the first reactor through the same means, i.e. through the same reactor inlet.

Preferably, the first reactor comprises one or more means for introducing (i) a gas comprising ozone and (ii) carbon dioxide into the reactor such that in use (i) the gas comprising ozone and (ii) carbon dioxide is introduced into the reactor through a venturi gas/liquid contactor or pre-contactor pressurised vessel, or fine bubble diffused through the spent caustic solution present in the reactor.

Preferably the apparatus (I) comprises a means for mixing a gas comprising ozone and carbon dioxide in fluid communication with the first reactor. The means for mixing the gas comprising ozone and carbon dioxide may, for example, be a venturi mixer, a jet mixer, an in-line static mixer, a diffuser (which may be located in the base of the reactor) or a gas/liquid contacting device in a pumped recycle sidestream. It is understood that the means for mixing a gas comprising ozone and carbon dioxide is preferably external to the first reactor. However, the means for mixing a gas comprising ozone and carbon dioxide may be internal to the first reactor.

Preferably the apparatus (I) comprises a means for mixing a gas comprising ozone and/or carbon dioxide and treated solution in fluid communication with the first reactor. The means for mixing the gas comprising ozone and/or carbon dioxide and treated solution may, for example, be a venturi mixer, a jet mixer, an in-line static mixer, a diffuser (which may be located in the base of the reactor) or a gas/liquid contacting device in a pumped recycle sidestream. It is understood that the means for mixing a gas comprising ozone and/or carbon dioxide and treated solution is preferably external to the first reactor. However, the means for mixing a gas comprising ozone and/or carbon dioxide and treated solution may be internal to the first reactor.

Preferably, the apparatus (I) further comprises an ozone source or an ozone generator in fluid communication with the first reactor and/or the means for mixing a gas comprising ozone and carbon dioxide and/or the means for mixing a gas comprising ozone and/or carbon dioxide and treated solution. Suitable ozone sources/generators are known in the art and are available, for example, from Xylem Wedeco, Fujitsu, Degremont Ozonia and Mitsubishi generator manufacturers.

Preferably, the apparatus (I) further comprises a means to monitor the pH of solution present in the first reactor. Suitable means of monitoring the pH of the solution include a pH probe with a pH controller.

Preferably, the apparatus (I) further comprises a pressure monitor in the first reactor. Suitable means of monitoring the pressure are known in the art, for example one or more pressure sensors connected to one or more transmitters.

Preferably, the apparatus (I) further comprises a pressure valve to control the pressure in the first reactor.

The first reactor may also comprise one or more gas outlets.

Off-gas present in the first reactor may optionally be recycled through a secondary venturi gas/liquid contactor placed on an internal recycle line from the first reactor to re-enter the first reactor.

Preferably, the first reactor comprises a means for discharging at least a portion of the treated solution from the reactor.

In a multi-reactor embodiment, the present invention also provides an apparatus (II) for treating a spent caustic solution, the apparatus (II) comprising:

a first reactor; and

a second reactor,

wherein each of the first reactor and the second reactor has an inlet for introducing solution and an outlet for removing solution; and

wherein the first reactor and the second reactor are in fluid communication with one another, such that, in use, solution can be transferred from the first reactor to the second reactor,

the first reactor comprising a means for introducing a gas comprising ozone into the reactor, and

the second reactor comprising a means for introducing carbon dioxide into the reactor.

Preferably the apparatus (II) further comprises a means for recycling solution from the second reactor to the first reactor.

Preferably, the apparatus (II) further comprises an ozone source or an ozone generator in fluid communication with the first reactor. Suitable ozone sources/generators are given above.

Preferably, the apparatus (II) further comprises a means to monitor the pH of solution present in the first reactor and/or second reactor. Suitable means of monitoring the pH of the solution include a pH probe with a pH controller.

Preferably, the apparatus (II) further comprises a pressure monitor in the first reactor and/or second reactor. Suitable means of monitoring the pressure are known in the art, for example one or more pressure sensors connected to one or more transmitters.

Preferably, the apparatus (II) further comprises a pressure valve to control the pressure in the first reactor and/or second reactor.

The first and/or second reactors may also comprise one or more gas outlets.

Preferably, the first reactor of apparatus (II) comprises a means for introducing a gas comprising ozone into the reactor such that in use the gas comprising ozone is introduced through a venturi gas/liquid contactor or pre-contactor pressurised vessel or fine bubble diffused through the spent caustic solution present in the reactor.

Off-gas present in the first reactor may optionally be recycled through a secondary venturi gas/liquid contactor placed on the internal recycle line between the first reactor and/or second reactor.

Alternatively, preferably, the apparatus (I) and (II) further comprise a combustion vessel in fluid communication with the first reactor and/or second reactor for combusting off-gas produced in the first reactor and/or second reactor with hydrogen.

Preferably, the apparatus (I) and (II) further comprise a means to recycle gas produced in the combustion vessel to the first reactor and/or the second reactor.

Preferably, the apparatus (I) and (II) further comprise a means to monitor the heat generated in the combustion vessel and/or a means to monitor combustion products. Means to monitor the heat generated in a combustion vessel are known in the art and may include temperature probes and sensors, measuring, for example, hot-wire resistance and infrared thermometers. Means to monitor combustion products are known in the art and may include instruments which use methods based on techniques such as non-dispersive infrared analysis (NDIR), electrochemical cells, UV-absorption analysis, and Fourier-Transform Infrared (FTIR) analysis, BS EN 14791.

Preferably, the apparatus (I) and (II) further comprise a means to monitor the total organic carbon (TOC) of the solution present in the first reactor and/or second reactor. Additionally or alternatively, preferably, the apparatus (I) and (H) further comprises a means to monitor the chemical oxygen demand (COD) of the solution present in the first reactor and/or second reactor. Means of monitoring TOC and/or COD are known in the art and include UV or IR spectrometers, for example LAR Process Analysers AG, which can provide on-line TOC, COD, TOD (total oxygen demand) analysis. The LAR Process Analyser AG may use a thermal combustion method in its analysis of TOC, COD and/or TOD.

Preferably, the apparatus (I) and (II) further comprises a programme logic controller (PLC) configured to control the amount and/or the make-up of the gas comprising ozone and/or carbon dioxide provided to the first reactor and/or second reactor. Suitable PLCs are known in the art and are available, for example, from Endress & Hauser, Brokhurst, Buerkert, Emerson control systems.

Preferably, the apparatus (I) and (II) further comprises:

(i) a means to monitor the pH of solution present in the first reactor and/or second reactor; and/or

(ii) a means to monitor the heat generated in the combustion vessel; and/or

(iii) a means to monitor combustion products; and/or

(iv) a means to monitor the total organic carbon of the solution present in the first reactor and/or second reactor; and/or

(v) a means to monitor the chemical oxygen demand of the solution present in the first reactor and/or second reactor;

wherein the programme logic controller is in communication with (i) and/or (ii) and/or (iii) and/or (iv) and/or (v).

Preferably, signals from (i), (ii), (iii), (iv) and/or (v) are communicated to the PLC and the PLC adjusts the amount and/or make-up of the gas comprising ozone and/or carbon dioxide accordingly. For example, if the pH of the solution is high, the PLC may increase the amount of carbon dioxide being sent to contact the solution in order to reduce the pH thereof. Alternatively, if the heat generated by the combustion of off-gas with hydrogen is high, meaning more carbon dioxide is being produced in the combustion vessel and recycled to the reactor, the PLC will reduce the amount of carbon dioxide taken from other sources. The PLC preferably also controls the amount of hydrogen used and may optionally turn off the flow of hydrogen when the heat generated by the combustion of off-gas with hydrogen reaches a constant value.

Preferably, the second reactor comprises a means for introducing carbon dioxide into the reactor such that in use the carbon dioxide is introduced via a gas/liquid venturi or bubbled through the partially treated solution present in the reactor.

Preferably, the second reactor comprises a means for discharging at least a portion of the treated solution from the reactor.

These and other aspects of the invention will now be described with reference to the accompanying Figures, in which:

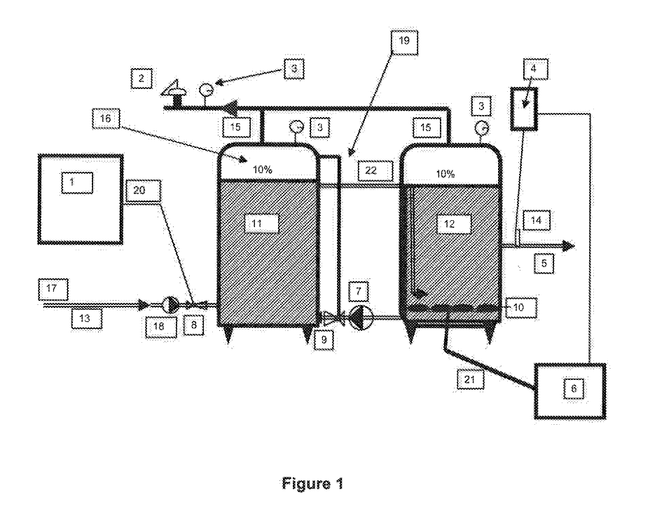

FIG. 1 is a schematic diagram of a multi-reactor apparatus and process according to the present invention.

### KEY TO FIG. 1

1=ozone generator
2=gas pressure control valve
3=pressure indicator/transmitter
4=pH control meter
5=treated solution outlet
6=CO₂ dosing panel
7=recycle pump
8=primary ozone gas/liquid contactor
9=secondary ozone gas liquid off-gas contactor
10=CO₂ fine bubble diffusers
11=first reactor
12=second reactor
13=inlet feed line
14=pH probe
15=gas outlet
16=gas space
17=spent caustic solution for treatment
18=feed pump
19=off-gas recycle
20=O₃/O₂
21=CO₂ gas
22=interconnecting pipe

FIG. 1 depicts an apparatus comprising a first reactor 11, and a second reactor 12. Inlet feed line 13 allows spent caustic solution 17 to be fed to the first reactor 11 and subsequently the second reactor 12, via interconnecting pipe 22. The first reactor 11 has a means for introducing a gas comprising ozone into the reactor via a gas liquid contacting device, such as a venturi/in-line static mixer or similar device 8. Off-gas from reactor 11 may be recycled back to reactor 11 via a secondary gas/liquid contacting device 9 connected in line with recycle pump 7. Contents from the second reactor 12 can be recycled back to first reactor 11 and the contents of first reactor 11 are connected by a gravity fed interconnecting pipe 22 to the second reactor 12. The second reactor 12 comprises a means 10 for introducing carbon dioxide. The second reactor 12 comprises a treated solution outlet 5. The second reactor 12 may also comprise a pH probe 14 optionally connected to a pH meter 4. In this embodiment the first reactor 11 comprises a means and a pump 7 to recycle solution from the second reactor 12 to first reactor 11. The first reactor 11 is in fluid communication with second reactor 12. In this schematic the first reactor 11 and the second reactor 12 respectively have a gas outlet 15 to allow excess gas to be removed.

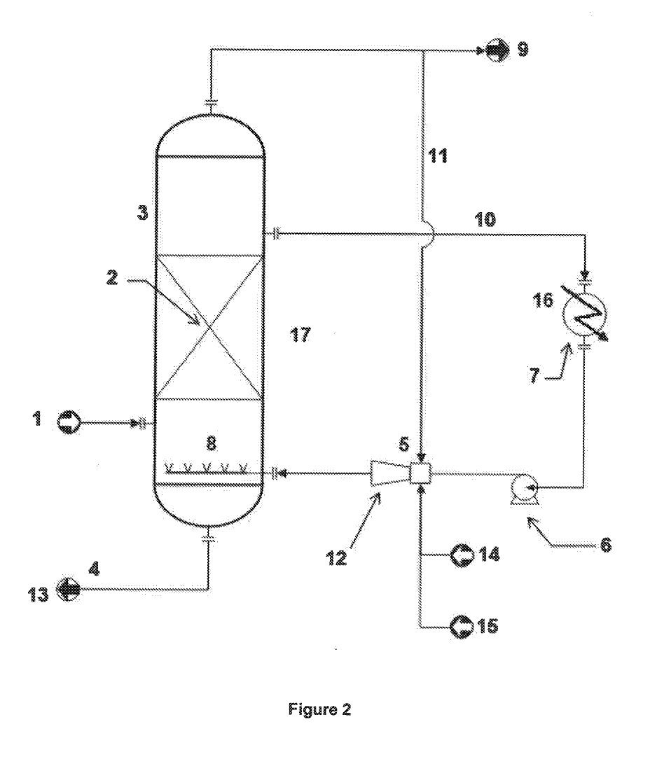

FIG. 2 is a schematic diagram of an apparatus and process for single-reactor batch processing according to the present invention.

### KEY TO FIG. 2

1=spent caustic delivery pump
2=vessel gas-liquid contacting packing material
3=reaction vessel
4=treated caustic solution transfer pump
5=venturi gas/liquid contactor
6=process recycle pump
7=heat exchanger
8=process mixer and distributor
9=gaseous effluent outlet
10=process liquid recycle line
11=gaseous recycle line
12=mixing ejector
13=to wastewater plant
14=CO₂
15=O₃/O₂
16=Heat
17=Temperature 20 to 140° C.

In one embodiment, the present invention may be operated as a batch process, for example using the apparatus/process shown in FIG. 2. The spent caustic solution enters the first reactor 3 by transfer pump 1 and is controlled by PLC/SCADA (not shown). The spent caustic solution to be treated is then cycled through the first reactor 3 and into the process fluid line 10, where it is optionally heated by a heat exchanger 7, for example a steam device or other heating medium. The spent caustic solution is pumped by pump 6 and enters the venturi gas/liquid contactor 5, where it is contacted with a gas comprising ozone and oxygen 15 and carbon dioxide 14. Recycle gas may also contact the spent caustic solution in the venturi gas/liquid contactor 5 via gaseous recycle line 11 or via an alternative mixing device. The liquid/gas mixture, i.e. the spent caustic solution and the gas comprising ozone, oxygen and carbon dioxide, is then injected into the first reactor 3 by means of a distributor or nozzle array 8. A portion of the first reactor 3 may be filled to a defined height (from 25% to 100%) with gas-liquid contacting packing material 2 (random or structured) to improve the contact between the gas phase and the liquid phase. To control and maintain the pressure in the first reactor 3, the exhaust gaseous are removed from the first reactor 3 and recycled via recycle line 11 and/or emitted via gaseous effluent outlet 9 to a thermal destruct unit (not shown) to breakdown any remaining ozone to oxygen.

When introducing elements of the present disclosure or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A process for treating spent caustic solution, the process comprising:
contacting a spent caustic solution with
(i) a gas comprising ozone; and
(ii) carbon dioxide;
to form a treated solution having a pH of 7.0 to 11.0; and
discharging at least a portion of the treated solution.

2. The process of claim 1, wherein the spent caustic solution comprises sodium hydroxide.

3. The process of claim 1, wherein the spent caustic solution is contacted with a gas comprising ozone in a first reactor to form a partially treated solution and the partially treated solution is contacted with carbon dioxide in a second reactor to form the treated solution.

4. The process of claim 3, wherein at least a portion of the treated solution is recycled from the second reactor to the first reactor.

5. The process of claim 1, wherein the spent caustic solution is contacted with a gas comprising ozone and carbon dioxide in a first reactor to form the treated solution.

6. The process of claim 5, wherein at least a portion of the spent caustic solution is contacted with the gas comprising ozone, carbon dioxide, or a mixture of ozone and carbon dioxide, prior to introducing the portion of the spent caustic solution and the gas into the first reactor.

7. The process of claim 1, wherein the gas comprising ozone consists of oxygen and ozone.

8. The process of claim 1, wherein the gas comprising ozone comprises a percentage volume ratio of ozone to oxygen of 10% to 15%.

9. The process of claim 1, wherein contacting the spent caustic solution with (i) a gas comprising ozone or (ii) carbon dioxide is carried out at a temperature of 20° C. to 140° C.

10. The process of claim 1, wherein the spent caustic solution is heated to a temperature of 20° C. to 140° C. before being contacted with (i) a gas comprising ozone and (ii) carbon dioxide.

11. The process of claim 1, wherein the process is carried out at a pressure of 1.0 barg to 2.5 barg.

12. The process of claim 1, wherein the process is carried out in a continuous process.

13. The process of claim 1, wherein the process is carried out in a batch process.

14. The process of claim 1, wherein the treated solution has a pH of 7.0 to 9.0.

15. The process of claim 1, wherein the spent caustic solution comprises heavy metals.

16. The process of claim 15, wherein the heavy metals comprise cobalt, molybdenum, or a combination of cobalt and molybdenum.

17. The process of claim 15, further comprising removing heavy metal carbonates and heavy metal oxides as precipitate from the treated solution prior to discharging at least a portion of said treated solution; wherein the treated solution has a pH of 10.0 to 11.0 prior to removing the heavy metal carbonates and heavy metal oxides as precipitate.

18. The process of claim 17, wherein the treated solution has a pH of 10.25 to 10.75 prior to removing the heavy metal carbonates and heavy metal oxides as precipitate.

19. The process of claim 17, wherein heavy metal carbonates and heavy metal oxides are removed via coagulation, filtration, gravity settlement, one or more hydrocyclones, centrifugation or evaporation.

20. The process of claim 19, wherein heavy metal carbonates and heavy metal oxides are removed via nano-filtration or ultra-filtration.

21. The process of claim 17, further comprising heating the removed heavy metal carbonates to a temperature of 400° C. to 800° C. to recover heavy metals and heavy metal oxides.

22. The process of claim 21, wherein the removed heavy metal carbonates are heated to a temperature of 500° C. to 700° C.

23. The process of claim 17, further comprising reducing the pH of the treated solution after removing heavy metal carbonates and heavy metal oxides.

24. The process of claim 1, wherein at least a portion of the treated solution is discharged as a discharge solution having a pH of 7.0 to 9.0.

25. The process of claim 24, wherein the discharge solution has a pH of 7.0 to 8.5.

26. The process of claim 25, wherein the discharge solution is discharged to a wastewater plant.

27. The process of claim 1, wherein
(i) the spent caustic solution comprises volatile organic components and the process produces an off-gas comprising at least a portion of said volatile organic components;
(ii) at least a portion of the off-gas is combusted in the presence of hydrogen to produce a recycle stream comprising carbon dioxide; and
(iii) the spent caustic solution is contacted with at least a portion of the recycle stream.

28. The process of claim 27, further comprising mixing at least a portion of the recycle stream with the gas comprising ozone, carbon dioxide, or a mixture of ozone and carbon dioxide before contacting the spent caustic solution.

29. The process of claim 27, wherein the recycle stream further comprises one or more of H₂SO₄, H₂SO₃, S₂O₃, SO₃, N₂O₅, NH₄NO₃ and NO₂.

30. The process of claim 1, wherein at least a portion of (i) the gas comprising ozone and (ii) carbon dioxide are mixed to provide a gas mixture comprising ozone and carbon dioxide before contacting the spent caustic solution and the partially treated solution.

31. The process of claim 1, wherein the gas comprising ozone comprises 5% to 20% by volume of ozone based on the total volume of the gas.

32. An apparatus for treating a spent caustic solution, the apparatus comprising:
a first reactor;
wherein the first reactor has an inlet for introducing a solution and an outlet for removing solution; and
the first reactor comprises a means for introducing a gas comprising ozone into the reactor and a means for introducing carbon dioxide into the reactor.

33. An apparatus for treating a spent caustic solution, the apparatus comprising:
a first reactor, and
a second reactor,
wherein each of the first reactor and the second reactor has an inlet for introducing solution and an outlet for removing solution; and
wherein the first reactor and the second reactor are in fluid communication with one another, such that, in use, solution can be transferred from the first reactor to the second reactor;
the first reactor comprising a means for introducing a gas comprising ozone into the reactor, and
the second reactor comprising a means for introducing carbon dioxide into the reactor.

34. The apparatus of claim 33, further comprising a means for recycling solution from the second reactor to the first reactor.

35. The apparatus of claim 32, further comprising an ozone source or an ozone generator in fluid communication with the first reactor.

36. The apparatus of claim 32, further comprising a means to monitor the pH of solution present in the first reactor.

37. The apparatus of claim 32, further comprising a pressure monitor in the first reactor.

38. The apparatus of claim 32, further comprising a pressure valve to control the pressure in the first reactor.

39. The apparatus of claim 32, further comprising a combustion vessel in fluid communication with the first reactor, for combusting off-gas produced in the first reactor with hydrogen.

40. The apparatus of claim 39, further comprising a means to recycle gas produced in the combustion vessel to the first reactor.

41. The apparatus of claim 39, further comprising a means to monitor the heat generated in the combustion vessel or a means to monitor combustion products.

42. The apparatus claim 32, further comprising a means to monitor the total organic carbon (TOC) of the solution present in the first reactor.

43. The apparatus claim 32, further comprising a means to monitor the chemical oxygen demand (COD) of the solution present in the first reactor.

44. The apparatus of claim 32, further comprising a programme logic controller (PLC) configured to control the amount or the make-up of the gas comprising ozone, carbon dioxide, or a mixture of ozone and carbon dioxide, provided to the first reactor.

45. The apparatus of claim 44, wherein the apparatus comprises one or more components selected from:
(i) a means to monitor the pH of solution present in the first reactor; or
(ii) a means to monitor the heat generated in the combustion vessel; or
(iii) a means to monitor combustion products; or
(iv) a means to monitor the total organic carbon of the solution present in the first reactor; or
(v) a means to monitor the chemical oxygen demand of the solution present in the first reactor;
wherein the programme logic controller is in communication with each component.

46. (canceled)

47. (canceled)

48. The apparatus of claim 33, further comprising an ozone source or an ozone generator in fluid communication with the first reactor.

49. The apparatus of claim 33, further comprising a means to monitor the pH of solution present in the first reactor, the second reactor or both the first reactor and the second reactor.

50. The apparatus of claim 33, further comprising a pressure monitor in the first reactor, the second reactor or both the first rector and the second reactor.

51. The apparatus of claim 33, further comprising a pressure valve to control the pressure in the first reactor, the second reactor or both the first reactor and the second reactor.

52. The apparatus of claim 33, further comprising a combustion vessel in fluid communication with the first reactor, the second reactor or both the first reactor and the second reactor, for combusting off-gas produced in the first reactor, the second reactor or both the first reactor and the second reactor with hydrogen.

53. The apparatus of claim 52, further comprising a means to recycle gas produced in the combustion vessel to the first reactor, the second reactor or both the first reactor and the second reactor.

54. The apparatus of claim 52, further comprising a means to monitor the heat generated in the combustion vessel or a means to monitor combustion products.

55. The apparatus claim 33, further comprising a means to monitor the total organic carbon (TOC) of the solution present in the first reactor, the second reactor or both the first reactor and the second reactor.

56. The apparatus claim 33, further comprising a means to monitor the chemical oxygen demand (COD) of the solution present in the first reactor, the second reactor or both the first reactor and the second reactor.

57. The apparatus of claim 33, further comprising a programme logic controller (PLC) configured to control the amount or the make-up of the gas comprising ozone, carbon dioxide, or a mixture of ozone and carbon dioxide provided to the first reactor, the second reactor or both the first reactor and the second reactor.

58. The apparatus of claim 57, wherein the apparatus comprises one or more components selected from:
(i) a means to monitor the pH of solution present in the first reactor, the second reactor or both the first reactor and the second reactor; or
(ii) a means to monitor the heat generated in the combustion vessel; or
(iii) a means to monitor combustion products; or
(iv) a means to monitor the total organic carbon of the solution present in the first reactor, the second reactor or both the first reactor and the second reactor; or
(v) a means to monitor the chemical oxygen demand of the solution present in the first reactor, the second reactor or both the first reactor and the second reactor;
wherein the programme logic controller is in communication with each component.
